(19) United States
(12) Patent Application Publication
(10) Pub. No.: US 2026/0148909 A1
(43) Pub. Date: May 28, 2026

(54) PUSH-BUTTON ASSEMBLY

(71) Applicant: Savox Communications Oy Ab (Ltd), Espoo (FI)

(72) Inventor: Heikki HAKAMÄKI, Espoo (FI)

(21) Appl. No.: 19/391,158

(22) Filed: Nov. 17, 2025

(30) Foreign Application Priority Data
Nov. 25, 2024 (EP) 24215035.7

(51) Int. Cl. H01H 13/14

(52) U.S. Cl. CPC H01H 13/14

(57) ABSTRACT

A push-button assembly for controlling an operational function of an apparatus is provided. The assembly includes a chassis with a base portion and a spaced cover portion that together define an internal volume. The cover portion has an opening, and the base portion carries an electrical switch facing that opening. A push-button body is positioned within the volume so that its top portion extends through the opening for user actuation, while its bottom portion engages the switch when the body is pressed toward the base. A frame extends laterally across the volume and holds the push-button body between opposite sides of the chassis. The frame is rotatable about a first axis at one side of the volume, allowing the opposite side of the push-button body to move toward or away from the switch. The push-button body is also rotatable about a second axis, enabling corresponding movement of its other side.

### CROSS-REFERENCE TO RELATED APPLICATION

This application claims the benefit of and priority to European Patent Office (EP) Patent Application No. 24215035.7 filed Nov. 25, 2024, the contents of which being incorporated by reference in their entirety herein.

### TECHNICAL FIELD

The present disclosure relates to a user-operable push-button assembly that is suitable for controlling an aspect of operation of an apparatus and, in particular, that is suitable for serving as a user-operable push-button assembly of a communication device.

### BACKGROUND

Even though a recent trend in development of user-interfaces (UIs) for operating devices of various types has resulted in increasing use of touchscreens, touchpads and corresponding technologies, traditional user-operable push-buttons are still an important part of UIs of various devices and apparatuses, such as communication devices, vehicles, heavy machinery, etc.

Push-buttons may provide an especially advantageous means for operating a device in conditions where a user typically wears protective clothing such as gloves that make it difficult or even impossible to operate a touchscreen or a touchpad, e.g. outdoors, in relatively cold, in relatively hot or in (otherwise) hazardous environments. Another example of operating conditions where push-buttons come handy are scenarios where a possibility for eyes-free operation of the device is important due to the need for the user to simultaneously direct his/her attention to his/her environment, e.g. when operating a vehicle or heavy machinery or when carrying out another task that requires the user's primary attention. Examples of the latter include various tasks by professionals such as firefighters, the police, emergency medical service (EMS) personnel, military personnel, etc.

One of the advantages of push-buttons in such operating conditions arises from the user physically pressing the push-button, where the physical movement of the push-button upon provides the user with immediate and concrete tactile feedback of the user having successfully operated push-button. However, in such a scenario it is equally important that an indication of the push-button being pressed in conveyed to the device the push-button serves to control in a reliable manner.

### BRIEF SUMMARY

It is an object of the present disclosure to provide a push-button assembly for controlling an aspect of operation of an apparatus in a reliable manner.

According to an embodiment, a push-button assembly for controlling an aspect of operation of an apparatus is provided, the push-button assembly comprising: a chassis comprising a base portion and a cover portion spaced apart from each other to form a volume therebetween, wherein the cover portion comprises an opening therethrough and the base portion comprises an electrical switch facing the opening; a push-button body arranged in said volume such that a top portion thereof extends into the opening provided in the cover portion to enable a user pressing the push-button body via the top portion and such that a bottom portion thereof is positioned against the electrical switch to cause actuation of the electrical switch in response to moving the push-button body towards the base portion; a frame arranged in said volume such that the frame extends in a lateral direction across the volume from its first side to its second side and the frame holds the push-button body with its first side adjacent to the first side of said volume and its second side adjacent to the second side of said volume, wherein the frame is rotatable with respect to the chassis about a fixed first axis positioned at a first end of the frame in the first side of said volume such that second side of the push-button body is selectively moveable closer to and away from the base portion together with rotary motion of the frame, and wherein in the push-button body is rotatable with respect to a second axis positioned at a second end of the frame in the second side of said volume such that the first side of the push-button body is selectively moveable closer to or away from the base portion together with rotary motion of the push-button body.

According to another embodiment, a device comprising a push-button assembly according to the embodiment described in the foregoing, where the push-button assembly is arranged for controlling at least one aspect of operation of the device or an apparatus communicatively coupled to the device.

According to an embodiment, a method for operating an electrical switch is provided, the method comprising: providing a push-button assembly comprising a chassis that comprises a base portion and a cover portion spaced apart from each other to form a volume therebetween, wherein the cover portion comprises an opening therethrough, wherein the base portion comprises the electrical switch facing the opening, and wherein a push-button body having a top portion, a bottom portion, a first side and a second side is arranged in said volume such that the first side of the push-button body is adjacent to a first side of said volume, the second side of the push-button body is adjacent to a second side of said volume, the top portion extends into the opening provided in the cover portion to enable a user pressing the push-button body via the top portion and the bottom portion is positioned against the electrical switch; rotating, in response to applying pressure on the top portion of the push-button body at a position that is closer to its first side than its second side, the push-button body about a first axis that has a fixed position with respect to the chassis in the first side of said volume such that second side of the push-button body moves closer to the base portion, thereby pressing the bottom portion of the push-button body against the electrical switch to actuate the electrical switch; rotating, in response to applying pressure on the top portion of the push-button body at a position that is closer to its second side than its first side, the push-button body about a second axis that is positioned in the second side of said volume and that is moveable with respect to the first axis with the rotation of push-button body about the first axis such that the first side of the push-button body moves closer to the base portion, thereby pressing the bottom portion of the push-button body against the electrical switch to actuate the electrical switch; and rotating, in response to applying pressure on the top portion of the push-button body at a position that is at substantially equal distance from its first side and its second side, the push-button body with respect to the first axis and with respect to the second axis such that the push-button body moves towards the base portion, thereby pressing the bottom portion of the push-button body against the electrical switch to actuate the electrical switch.

The exemplifying embodiments of the disclosure presented in this patent application are not to be interpreted to pose limitations to the applicability of the appended claims. The verb “to comprise” and its derivatives are used in this patent application as an open limitation that does not exclude the existence of also unrecited features.

Some features of the disclosure are set forth in the appended claims. Aspects of the disclosure, however, both as to its construction and to its operation, together with additional objects and advantages thereof, will be best understood from the following description of some example embodiments when read in connection with the accompanying drawings.

### BRIEF DESCRIPTION OF FIGURES

The embodiments of the disclosure are illustrated by way of example, and not by way of limitation, in the figures of the accompanying drawings, where

FIG. 1A schematically illustrates some components of a push-button assembly according to an example;

FIG. 1B schematically illustrates a push-button assembly according to an example;

FIG. 1C schematically illustrates a push-button assembly according to an example;

FIG. 2A schematically illustrates a push-button body according to an example;

FIG. 2B schematically illustrates a push-button body according to an example;

FIG. 2C schematically illustrates a push-button body according to an example;

FIG. 3A schematically illustrates an aspect of operation of a push-button assembly according to an example;

FIG. 3B schematically illustrates an aspect of operation of a push-button assembly according to an example;

FIG. 4A schematically illustrates an aspect of operation of a push-button assembly according to an example;

FIG. 4B schematically illustrates an aspect of operation of a push-button assembly according to an example;

FIG. 5A schematically illustrates an aspect of operation of a push-button assembly according to an example;

FIG. 5B schematically illustrates an aspect of operation of a push-button assembly according to an example;

FIG. 6A schematically illustrates an aspect of operation of a push-button assembly according to an example;

FIG. 6B schematically illustrates an aspect of operation of a push-button assembly according to an example;

FIG. 7 schematically illustrates a frame according to an example; and

FIG. 8 illustrates a method according to an example.

### DETAILED DESCRIPTION

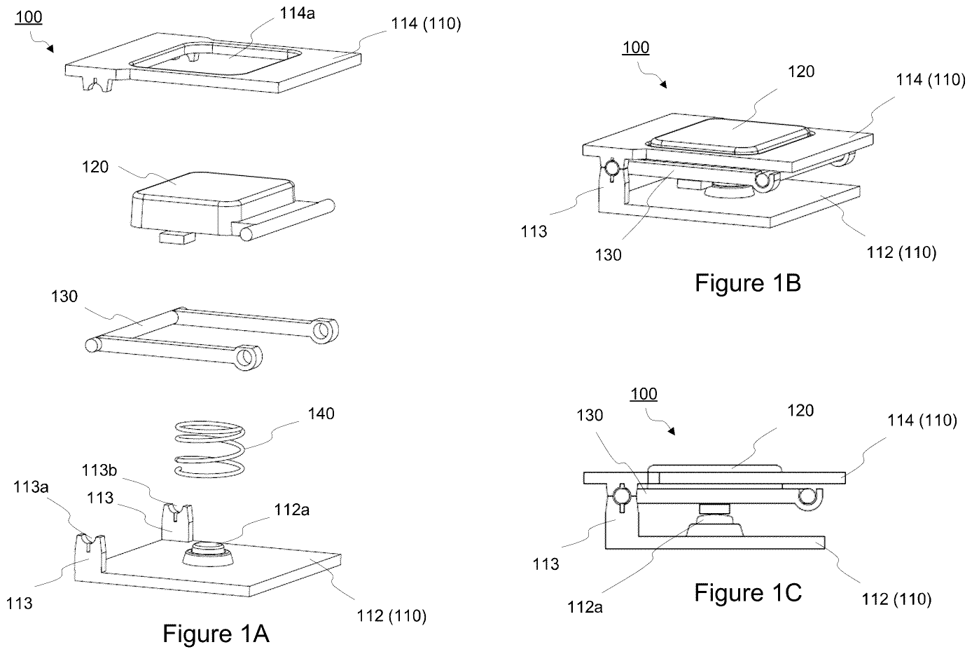

Respective illustrations of FIGS. 1A, 1B and 1C schematically illustrates some components of a push-button assembly 100 according to an example. The push-button assembly 100 comprises a chassis 110 that comprises a base portion 112 and a cover portion 114, a push-button body 120, and a frame 130. In particular, the illustration of FIG. 1A shows a perspective view to the base portion 112, the cover portion 114, the push-button body 120 and the frame 130 provided separately from each other, the illustration of FIG. 1B shows a perspective view to the push-button assembly 100 in its assembled form, and the illustration of FIG. 1C shows a side view to the push-button assembly 100 in its assembled form. As shown in the illustration of FIG. 1A, the push-button assembly 100 may further comprise a spring 140 arranged between the push-button body 120 and the base portion 112.

The push-button assembly 100 according to the present disclosure may be applied for controlling an aspect of operation of an apparatus. In this regard, the push-button assembly 100 may be provided as part of a user interface (UI) or a control panel of the apparatus or as part of a device operated to provide the UI for the apparatus, whereas the push-button assembly 100 may be provided in the housing of such an apparatus or device. The push-button assembly 100 according to the present disclosure is basically applicable as a user-operable control means for any apparatus that requires control by a user, whereas non-limiting examples in this regard include communication devices, vehicles of various kind, heavy machinery for outdoor and industrial purposes, etc. In a particular example, the push-button assembly 100 according to the present disclosure is applied as a push-to-talk (PTT) button of a mobile communication device, e.g. one intended for use by professionals such as firefighters, the police, EMS personnel, military personnel, etc. in potentially challenging operating conditions.

As described above, the chassis 110 comprises the base portion 112 and the cover portion 114, where these two components are spaced apart from each to form a volume therebetween. The volume between the base portion 112 and the cover portion 114 is provided to accommodate the push-button body 120 together with the frame 130 therein, as described in further detail in the following. The cover portion 114 comprises an opening 114a therethrough, whereas the base portion 112 comprises an electrical switch 112a facing the opening 114a through the cover portion 114. In some examples, the cover portion 114 and the base portion 112 are provided separately from each other (cf. FIG. 1A) and they are attached to each to form the chassis 110 (cf. FIGS. 1B and 1C), whereas in some examples the chassis 110 is readily provided as a one-piece structure as shown in respective illustrations of FIGS. 1B and 1C. In the examples shown in FIGS. 1A, 1B and 1C, the base portion 112 and the cover portion 114 are physically connected to each other via a pair of support members 113, whereas in further examples the base portion 112 and the 114 are not physically connected to each other by dedicated support members but they are separately supported e.g. via respective structures of a housing of the apparatus operation of which the push-button assembly 100 serves to control.

According to an example, the push-button assembly 100 is provided as a separate entity for installation in a housing of the apparatus operation of which is serves to control. In such a scenario, the housing may be provided with a recess for receiving the push-button assembly 100 with the necessary electrical connections for electrical coupling to the electrical switch 112a provided in the recess. In another example, the push-button assembly 100 is partially integrated to the housing of the apparatus operation of which is serves to control, e.g. such that the base portion 112 is provided as part of (the housing of) the apparatus and/or such that the cover portion 114 is provided as part of the housing of the apparatus.

In the present disclosure, the electrical switch 112a comprises an electro-mechanical structure, where actuation of the electrical switch 112a is accomplished via exerting a sufficient force on the electrical switch 112 from a reference direction, whereas de-actuation (i.e. a lack of actuation) of the electrical switch 112a follows from absence of a sufficient force exerted thereon from the reference direction. Actuation may result in the electrical switch 112a supplying an electrical signal of certain electrical characteristics, whereas lack of actuation may result in the electrical switch 112a not supplying an electrical signal or supplying an electrical signal of different electrical characteristics.

The electrical switch 112a of the base portion 112 is provided for controlling an aspect of operation of an apparatus, whereas an effect caused in operation of the apparatus upon actuating or de-actuating the electrical switch 112a depends on operational characteristics of the apparatus and the role of the push-button assembly 100 in controlling the apparatus. In the non-limiting example of using the push-button assembly 100 as a PTT button of a mobile communication device, actuation of the electrical switch 112a opens a voice channel from the mobile communication device over a wireless communication channel or network to one or more other communication devices, whereas de-actuation of the electrical switch 112a closes the voice channel.

Typically, the base portion 112 and the cover portion 114 are arranged on respective (conceptual) planes that are substantially parallel to each other with the reference direction (of the electrical switch 112a) being perpendicular to these (conceptual) planes. In this regard, a direction perpendicular to the above-described (conceptual) planes may be referred to as a vertical direction, whereas a direction parallel to the above-described (conceptual) planes may be referred to as a horizontal direction. Moreover, any direction whose angle with the vertical direction (and hence with the reference direction) is larger than 45 degrees may be considered as a lateral direction. It is worth noting that the terms vertical direction and horizontal direction are applied herein as spatial references with respect to the push-button assembly 100, whereas their alignment (or lack thereof) with real-world vertical and horizontal directions depends on orientation of the push-button assembly 100 with respect to its operating environment and it may vary over time.

According to an example, the opening 114a through the cover portion 114 is substantially rectangular, e.g. substantially square-shaped. Herein, the word ‘substantially’ is used to account for the fact that in a real implementation the shape of the opening 114a may not be strictly rectangular but it may approximate a shape of a rectangle with rounded or beveled vertices. In other examples, the shape of the opening 114a through the cover portion 114 may be different from substantially rectangular one, e.g. substantially circular or substantially oval-shaped, etc. According to an example, the electrical switch 112a in the base portion 112 is positioned with respect to the opening 114a such that its projection in the vertical direction meets the opening 114a substantially at its center. Alternatively or additionally, the electrical switch 112a is positioned with respect to the opening 114a such that it resides substantially at a center of a projection of the opening 114a in the vertical direction.

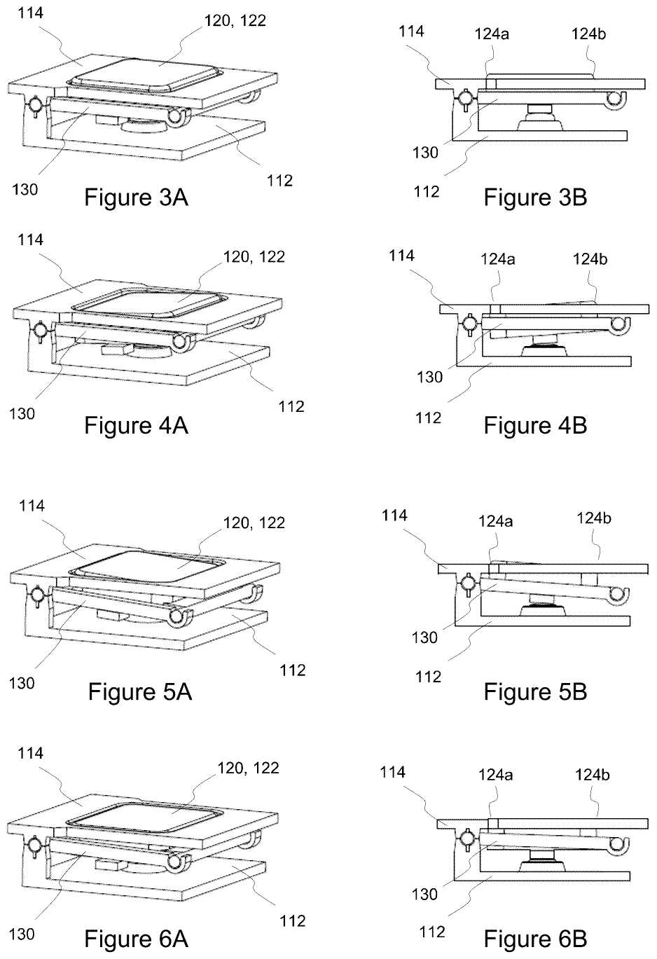

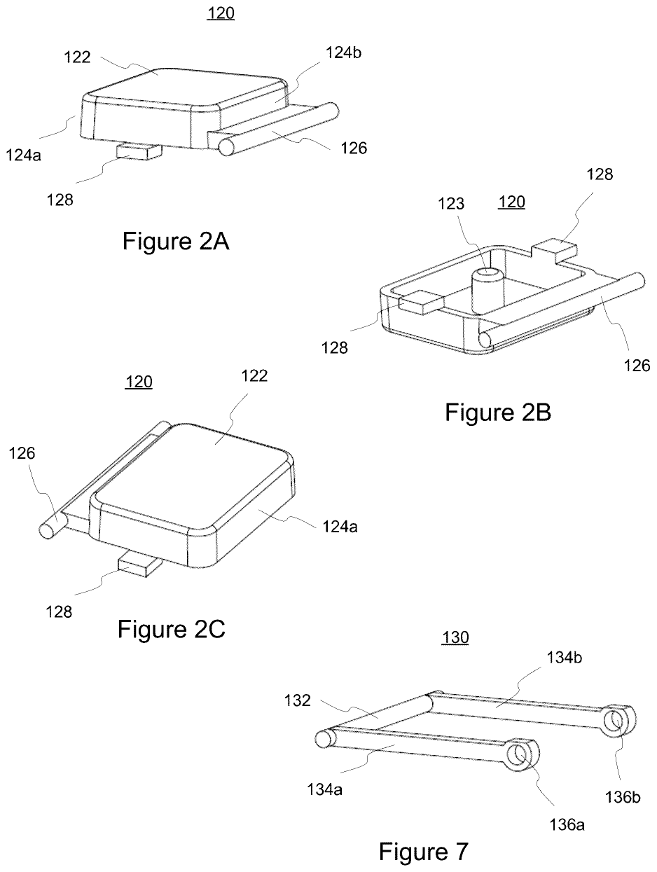

Along the lines described in the foregoing, the push-button body 120 is arranged in the volume between the base portion 112 and the cover portion 114. FIGS. 2A, 2B and 2C schematically illustrate the push-button body 120 according to a non-limiting example from respective different directions. In the example of FIGS. 2A, 2B and 2C, the push-button body 120 is shown as a block having a substantially rectangular cross-section in the horizontal direction with a top portion 122 that extends into the opening provided in the cover portion 114 to enable user operating the push-button assembly 100 via pressing the top portion 122 of the push-button body 120 and a bottom portion 123 on a side of the block opposite of the top portion 122 that is arranged against the electrical switch 112a such that movement of any part of the push-button body 120 towards base portion 112 causes the bottom portion 123 to press the electrical switch 112. Moreover, the push-button body 120 at least conceptually has a first side 124a and a second side 124b that is opposite to the first side 124. Hence, the top portion 122 and the bottom portion 123 are respective ends of the push-button body 120 along the vertical direction while the first and second sides 124a, 124b of the push-button body 120 are its respective ends along the horizontal direction.

The push-button body 120 is moveable with respect to the chassis 110 such that pressing the top portion 122 causes tilting of the push-button body 120 and/or vertical movement of the push-button body 120 towards the base portion 112. When no pressure is applied to the top portion 122, the push-button body 120 remains in (or returns to) an idle position, whereas any movement of the push-button body 120 due to the pressure applied on the top portion 122 sets it into a pressed position. Along the lines described in the foregoing, the spring 140 illustrated in FIG. 1A may be arranged between the push-button body 120 and the base portion 112 to exert a force that pushes the push-button body 120 away from the base portion 112, thereby keeping or returning the push-button body 120 in the idle position when no pressure is applied on the top portion 122. In other examples, a mechanism different from the spring 140 may be applied to keep or return the push-button body into the idle position when no pressure is applied on the top surface 122

In particular, the push-button body 120 according to the example illustrated via FIGS. 1A, 2A, 2B and 2C may be considered as a dome-shape structure that has a substantially rectangular cross-section and a substantially planar closed end forming the top portion 122, whereas the bottom portion 123 is provided a protrusion extending towards the open end the dome-shaped structure within the recess formed in the interior of the dome-shaped structure. Moreover, the first and second sides 124a, 124b are provided as opposite sides of the dome-shaped structure. For the push-button body 120 having such a structure, the spring 140 may be positioned in the recess such that it surrounds the protrusion that forms the bottom portion 123. In other examples, the shape of the element that servers as the push-button body 120 may have a shape different from that described above and illustrated via FIGS. 2A, 2B and 2C while still having the top portion 122, the bottom portion 123 and the first and second sides 124a, 124b serving roles and having placement with respect to the chassis 110 according to the description above. In such other designs, the placement of the spring 140 with respect to the push-button body 120 may be different from that described above for the push-button body according to the example of FIGS. 2A, 2B and 2C and/or a mechanism different from the spring 140 may be applied to ensure keeping or returning the push-button body 120 to the idle position when no pressure is applied on the top portion 122.

The frame 130 is likewise arranged in the volume between the base portion 112 and the cover portion 114 such that it extends in a lateral direction across the volume from a first side of the volume to a second side of the volume, where the second side is a side opposite to the first side. Herein, the first and second sides of the volume are respective positions at opposite sides of the volume along the horizontal direction. The frame 130 is arranged to hold the push-button body 120 in the volume between the base portion 112 and the cover portion 114 such that the first side 124a of the push-button body 120 is adjacent to the first side of the volume and the second side 124b of the push-button body 120 is adjacent to the second side of said volume. Moreover, the arrangement of push-button body 120 with respect to the frame 130 is such that, depending on a position of the top portion 122 of the push-button body 120 being pressed, the frame 130 moves together with the push-button body 120 and/or the push-button body 120 moves with respect to the frame 130, as described in the following in further detail.

The top portion 122 of the push-button body 120 has a shape and size that enable the opening 114 to accommodate the top portion 122 in a manner that enables both a linear movement of the top portion 122 through the opening 114a in the vertical direction and tilting of the top portion 122 with respect to the cover portion 114 (and hence with respect to the horizontal direction) in response to a user pressing the top portion 122 of the push-button body 120. In this regard, pressing the top portion 122 of the push-button body 120 to set it into the pressed position results in moving the first side 124a and/or the second side 124b of the push-button body 120 towards the base portion 112, thereby pressing the bottom portion 123 of the push-button body 120 against the electrical switch 112a to actuate the electrical switch 112a (via exerting a sufficient force thereon from the reference direction). In contrast, when no pressure is applied on the top portion 122 of the push-button body 120, it remains in the idle position and the bottom portion 1233 rests against the electrical switch 112a without applying a substantial pressure thereon and, consequently, no actuation takes place.

The frame 130 is rotatable about a first axis positioned at a first end of the frame 130 in the first side of the volume between the base portion 112 and the cover portion 114, thereby moving the frame 130 with respect to the chassis 110. The first axis extends in a horizontal direction to enable rotary motion of the frame 130 that brings at least a portion of the push-button body 120 closer to or away from the base portion 112. The first axis is fixed in the sense that its position with respect to the chassis 110 (or to other components of the push-button assembly 100) does not change with rotary motion of the frame 130. Hence, the second side 124b of the push-button body 120 is selectively moveable closer to and away from the base portion 112 together with rotary motion of the frame 130. Consequently, such tilting of the push-button body 120 to bring its second side 124b towards the base portion 112 enables pressing its bottom portion 123 against the electrical switch 112a to cause actuation of the electrical switch 112a (via exerting a sufficient force thereon from the reference direction).

The push-button body 120 is rotatable with respect to a second axis positioned at the second end of the frame 130 in the second side of the volume between the base portion 112 and the cover portion 114 such that the push-button body 120 tilts with respect to the chassis 110 and with respect to the frame 130. The second axis is substantially parallel to the first axis and hence it likewise extends in a horizontal direction to enable rotary motion of the push-button body 120 that brings at least a portion of the push-button body 120 closer to or away from the base portion 112. Herein, the second end of the frame 130 is an end opposite to its first end. The second axis moves with respect to chassis 130 together with the rotary motion of the frame 130, thereby also changing the position of the second axis with respect to the first axis. Hence, the first side 124a of the push-button body 120 is selectively moveable closer to or away from the base portion 112 together with rotary motion of the push-button body 120. Consequently, such tilting of the push-button body 120 to bring its first side 124a towards the base portion 112 results in pressing its bottom portion against the electrical switch 112a to cause actuation of the electrical switch 112a (via exerting a sufficient force thereon from the reference direction).

The exact manner of movement of the push-button body 120 with respect to the chassis 110 depends on the position of the top portion 122 pressed by a user. In this regard, the schematic illustrations of FIGS. 3A and 3B provide, respectively, a perspective view and a side view to the push-button assembly with the push-button body 120 in the idle position, whereas FIGS. 4A, 4B, 5A, 5B, 6A and 6B provide corresponding schematic illustrations of different pressed positions of the push-button body 120.
The schematic illustrations of FIGS. 4A and 4B provide, respectively, a perspective view and a side view to the push-button assembly 110 with the push-button body 120 in the pressed position when applying pressure on (e.g. via the user pressing) the top portion 122 of the push-button body 120 in a position that is closer to its first side 124a than its second side 124b. In such a scenario, the push-button body 120 rotates about the second axis, resulting in tilting of the push-button body 120 in a manner that moves its first side 124a towards the base portion 112, thereby pressing the bottom portion 123 of the push-button body 120 against the electrical switch 112a to actuate the electrical switch 112a.
The schematic illustrations of FIGS. 5A and 5B provide, respectively, a perspective view and a side view to the push-button assembly 110 with the push-button body 120 in the pressed position when applying pressure on (e.g. the user pressing) the top portion 122 of the push-button body 120 in a position that is closer to its second side 124b than its first side 124a. In such a scenario, the frame 130 rotates about the first axis, resulting in tilting of the push-button body 120 in a manner that moves its second side 124b towards the base portion 112, thereby pressing the bottom portion 123 of the push-button body 120 against the electrical switch 112a to actuate the electrical switch 112a.
The schematic illustrations of FIGS. 6A and 4B provide, respectively, a perspective view and a side view to the push-button assembly 110 with the push-button body 120 in the pressed position when applying pressure on (e.g. via the user pressing) the top portion 122 of the push-button body 120 in a position that is at a substantially equal distance from its first and second sides 124a, 124b. In such a scenario, the frame 130 rotates about the first axis and the push-button body 120 rotates about the second axis, resulting in movement of the push-button body 120 in the vertical direction towards the base portion 112 and thereby pressing the bottom portion 123 of the push-button body 120 against the electrical switch 112a to actuate the electrical switch 112a.

Hence, regardless of the position of the top portion 122 of the push-button body 120 pressed by the user, the dual-axis structure of the push-button assembly 100 results in movement of the push-button body 120 that reliably applies the pressure on electrical switch 112a to cause actuation of the electrical switch 112a while at the same time providing the user with immediate physical tactile feedback regarding successfully actuating the electrical switch 112a via pressing the push-button body 120.

FIG. 7 schematically illustrates the frame 130 according to an example, wherein the frame 130 comprises a first hinge pin 132 arranged at its first end and a pair of arms 134a, 134b that extend from the first hinge pin 132, where each of the arms 134a, 134b has a respective second hinge socket 136a, 136b arranged at is distal end. When arranged to its position in the push-button assembly 100, the first hinge pin 132 extends along the first axis and each of the second hinge sockets 136a, 136b is arranged at a respective position along the second axis, thereby making the arms 134a, 134b to extend from the first side of the volume between the base portion 112 and the cover portion 114 to

the second side of said volume. In this regard, the first hinge pin 132 may be fitted to a pair of first hinge sockets 113a, 113b provided as respective bores arranged in respective support members 113 that hold the cover portion 114 at the desired distance from the base portion 112, hence connecting the base portion 112 to the cover portion 114. Moreover, as shown in the respective illustrations of FIGS. 2A, 2B and 2C, the push-button body 120 may have a second hinge pin 126 arranged to its second side 124b. When the push-button body 120 is arranged to its position in the push-button assembly 100, the second hinge pin 126 extends along the second axis and it is fitted to the pair of second hinge sockets 136a, 136b such that rotation of the push-button body 120 with respect to the frame 130 is enabled.

It is worth noting that the structure of the frame 130 illustrated in and described with references to FIG. 7 is a non-limiting example and structural elements of the frame 130 that enable holding the push-button body 120, that enable the rotation of the frame 130 about the first axis and/or that enable the rotation of the push-button body 120 with respect to the frame 130 may be different from the arms 134a, 134b with the respective second hinge sockets 136a, 136b is arranged in their distal ends applied in this example.

The push-button body 120 may further comprise one or more tabs 128 that extends in a lateral direction, e.g. in the horizontal direction, such that each tab 128 is positioned against a side of the frame 130 that is facing the base portion 112 when the push-button body 120 is arranged in its position in the push-button assembly 100. Such positioning of the one or more tabs 128 with respect to the frame 130 prevents movement of the push-button body 120 with respect to the frame 130 in the ‘wrong’ direction, i.e. such that the first side 124a of the push-button body 120 moves away from the base portion 112 upon applying pressure on a position of the top portion 122 of the push-button body 120 that is closer to its second side 124b than its first side 124a, while it also facilitates firmly holding the push-button body 120 against the frame 120 both in idle and pressed positions of the push-button 120. If assuming the frame 130 having a structure shown in the example of FIG. 7, the each of the one or more tabs 128 may be positioned against the first hinge pin 132 or against one of the arms 134a, 134b such that is positioned on the side of the first hinge pin or the arm 134a, 134b that is facing the base portion 112. In the former approach, the respective tab 128 may extend from the first side 124a of the push-button body 120, whereas in the latter approach the respective tab 128 may extend from a third side of the push-button body 120, where the third side is a side of the push-button body 120 that connects its first side 124a to its second side 124b.

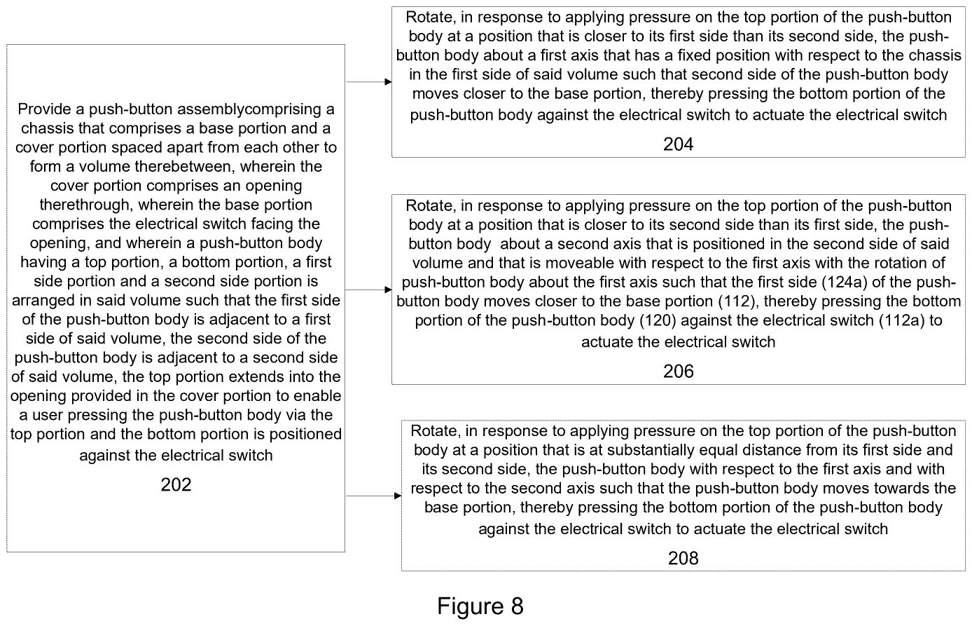

While described in the foregoing predominantly via the exemplifying structural characteristics, operation of the push-button assembly 100 according to the present disclosure may be also described as steps of a method. As an example in this regard, FIG. 8 illustrates a method 200 for operating the electrical switch 112a, where the method 120 comprises:
providing the push-button assembly 100 comprising the chassis 110 that comprises a base portion 112 and a cover portion 114 spaced apart from each other to form a volume therebetween, wherein the cover portion comprises the opening 114a therethrough, wherein the base portion 112 comprises the electrical switch 112a facing the opening 114a, and wherein a push-button body 120 having the top portion 122, the bottom portion 123, the first side 124a and the second side 124b is arranged in said volume such that the first side 124a of the push-button body 120 is adjacent to the first side of said volume, the second side 124b of the push-button body is adjacent to the second side of said volume, the top portion 122 extends into the opening 114a provided in the cover portion 114 to enable a user pressing the push-button body 120 via the top portion 122 and the bottom portion 123 is positioned against the electrical switch 112a (block 202);
rotating, in response to applying pressure on the top portion 122 of the push-button body 120 at a position that is closer to its first side 124a than its second side 124b, the push-button body 120 about the first axis that has a fixed position with respect to the chassis 110 in the first side of said volume such that second side 124b of the push-button body 120 moves closer to the base portion 112, thereby pressing the bottom portion 123 of the push-button body 120 against the electrical switch 112a to actuate the electrical switch 112a (block 204);
rotating, in response to applying pressure on the top portion 122 of the push-button body 120 at a position that is closer to its second side 124b than its first side 124a, the push-button body 120 about the second axis that is positioned in the second side of said volume and that is moveable with respect to the first axis with the rotation of the push-button body 120 about the first axis such that the first side 124a of the push-button body 120 moves closer to the base portion 112, thereby pressing the bottom portion 123 of the push-button body 120 against the electrical switch 112a to actuate the electrical switch 112a (block 206); and
rotating, in response to applying pressure on the top portion 122 of the push-button body 120 at a position that is at substantially equal distance from its first side 124a and its second side 124b, the push-button body 120 with respect to the first axis and with respect to the second axis such that the push-button body 120 moves towards the base portion 112, thereby pressing the bottom portion 123 of the push-button body 120 against the electrical switch 112a to actuate the electrical switch 112a (block 208). The respective operations described above with references to blocks 204, 206 and 208 are not necessarily performed in the order they appear in the description of the method 200 above but, for example, respective operations described with a reference to one of the blocks 204, 206, 208 may be carried out in any order and/or respective operations described with a reference to one of the blocks 204, 206, 208 may be repeatedly carried out before carrying out those described with a reference to another one of the blocks 204, 206, 208. The method 200 may be varied and/or complemented in various ways without departing from the scope of the present disclosure, e.g. in accordance to the examples that pertain to structure and operation of the push-button assembly provided in the foregoing.

1. A push-button assembly for controlling an aspect of operation of an apparatus, the push-button assembly comprising:
a chassis comprising a base portion and a cover portion spaced apart from each other to form a volume therebetween, wherein the cover portion comprises an opening therethrough and the base portion comprises an electrical switch facing the opening;
a push-button body arranged in the volume such that a top portion thereof extends into the opening provided in the cover portion to enable a user pressing the push-button body via the top portion and such that a bottom portion thereof is positioned against the electrical switch to cause actuation of the electrical switch in response to moving the push-button body towards the base portion;
a frame arranged in the volume such that the frame extends in a lateral direction across the volume from its first side to its second side and the frame holds the push-button body with its first side adjacent to the first side of the volume and its second side adjacent to the second side of the volume,
wherein the frame is rotatable with respect to the chassis about a fixed first axis positioned at a first end of the frame in the first side of the volume such that second side of the push-button body is selectively moveable closer to and away from the base portion together with rotary motion of the frame, and
wherein in the push-button body is rotatable with respect to a second axis positioned at a second end of the frame in the second side of the volume such that the first side of the push-button body is selectively moveable closer to or away from the base portion together with rotary motion of the push-button body.

2. The push-button assembly according to claim 1, wherein the first end of the frame comprises a first hinge pin that extends along the first axis and that is fitted to a pair of first hinge sockets arranged on the first side of the volume such that rotation of the frame about the first axis is enabled.

3. The push-button assembly according to claim 2, wherein the pair of first hinge sockets is provided as respective bores arranged in respective support members that connect the base portion to the cover portion.

4. The push-button assembly according to claim 1, wherein
the second end of the frame comprises a pair of second hinge sockets, and
the push-button body comprises a second hinge pin arranged to its second side, where the second hinge pin extends along the second axis and it is fitted to the pair of second hinge sockets such that rotation of the push-button body with respect to the frame is enabled.

5. The push-button assembly according to claim 4, wherein the frame comprises a pair of arms extending from its first end towards its second end, where each arm has the respective second hinge socket arranged at its distal end.

6. The push-button assembly according to claim 1, wherein the frame comprises a first hinge pin arranged at its first end and a pair of arms extending from the first hinge pin towards the second end of the frame, where each arm has a respective second hinge socket arranged at its distal end,
the frame is arranged in the volume such that the first hinge pin extends along the first axis and that the first hinge pin is fitted to a pair of first hinge sockets arranged on the first side of the volume such that rotation of the frame about the first axis is enabled, and
the push-button body comprises a second hinge pin arranged to its second side and the push-button body is arranged in the volume such that the second hinge pin extends along the second axis and it is fitted to the respective second hinge sockets arranged at the distal ends of the respective arms such that rotation of the push-button body with respect to the frame is enabled.

7. The push-button assembly according to claim 1, wherein the push-button body comprises one or more tabs that laterally extends therefrom and that are positioned against a side of the frame facing the base portion, the one or more tabs thereby preventing rotation of the push-button body with respect to the frame such that the first side of the push-button body moves away from the cover portion.

8. The push-button assembly according to claim 1, wherein the push-button body is arranged to rotate about the second axis to move the first side of the push-button body towards the base portion in response to applying pressure on the top portion of the push-button body at a position that is closer to its first side than its second side, thereby pressing the bottom portion of the push-button body against the electrical switch to actuate the electrical switch.

9. The push-button assembly according to claim 1, wherein the frame is arranged to rotate about the first axis to move the second side of the push-button body towards the base portion in response to applying pressure on the top portion of the push-button body at a position that is closer to its second side than its first side, thereby pressing the bottom portion of the push-button body against the electrical switch to actuate the electrical switch.

10. The push-button assembly according to claim 1, wherein the frame is arranged to rotate about the first axis and the push-button body is arranged to rotate about the second axis to move the push-button body towards the base portion in response to applying pressure on the top portion of the push-button body at a position that is at substantially equal distance from its first side and its second side, thereby pressing the bottom portion of the push-button body against the electrical switch to actuate the electrical switch.

11. The push-button assembly according to claim 1, comprising a spring arranged between the push-button body and the base portion such that the spring exerts force that pushes the push-button body away from the base portion.

12. A device comprising a push-button assembly according to claim 1, where the push-button assembly is arranged for controlling at least one aspect of operation of the device or an apparatus communicatively coupled to the device.

13. The device according to claim 12, wherein the device comprises a mobile communication device.

14. The device according to claim 13, wherein the push-button assembly is a push-to-talk, PTT, switch of the mobile communication device.

15. A method for operating an electrical switch, the method comprising:
providing a push-button assembly comprising a chassis that comprises a base portion and a cover portion spaced apart from each other to form a volume therebetween, wherein the cover portion comprises an opening therethrough, wherein the base portion comprises the electrical switch facing the opening, and wherein a push-button body having a top portion, a bottom portion, a first side and a second side is arranged in the volume such that the first side of the push-button body is adjacent to a first side of the volume, the second side of the push-button body is adjacent to a second side of the volume, the top portion extends into the opening provided in the cover portion to enable a user pressing the push-button body via the top portion and the bottom portion is positioned against the electrical switch:
rotating, in response to applying pressure on the top portion of the push-button body at a position that is closer to its first side than its second side, the push-button body about a first axis that has a fixed position with respect to the chassis in the first side of the volume such that second side of the push-button body moves closer to the base portion, thereby pressing the bottom portion of the push-button body against the electrical switch to actuate the electrical switch;
rotating, in response to applying pressure on the top portion of the push-button body at a position that is closer to its second side than its first side, the push-button body about a second axis that is positioned in the second side of the volume and that is moveable with respect to the first axis with the rotation of push-button body about the first axis such that the first side of the push-button body moves closer to the base portion, thereby pressing the bottom portion of the push-button body against the electrical switch to actuate the electrical switch; and
rotating, in response to applying pressure on the top portion of the push-button body at a position that is at substantially equal distance from its first side and its second side, the push-button body with respect to the first axis and with respect to the second axis such that the push-button body moves towards the base portion, thereby pressing the bottom portion of the push-button body against the electrical switch to actuate the electrical switch.
